(19) United States
(12) Patent Application Publication
(10) Pub. No.: US 2025/0349456 A1
(43) Pub. Date: Nov. 13, 2025

(54) INDUCTOR ASSEMBLIES AND STACKED POWER SUPPLY CONFIGURATIONS

(71) Applicant: Infineon Technologies Austria AG, Villach (AT)

(72) Inventors: Wenkang Huang, East Greenwich, CT (US); Danny R. Clavette, Greene, RI (US)

(21) Appl. No.: 18/656,646

(22) Filed: May 7, 2024

(51) Int. Cl. H01F 27/28; H01F 27/24; H01F 41/02; H02M 3/00

(52) U.S. Cl. CPC H01F 27/28; H01F 27/24; H01F 41/0206; H02M 3/003

(57) ABSTRACT

According to one configuration, an inductor assembly comprises: a first material, second material, and one or more electrically conductive paths. A first electrically conductive path extends through the first material. In one example, the first material is not magnetically permeable material or has a low magnetic permeability. The second electrically conductive path extends through the second material. In one example, the second material is magnetically permeable material and has a higher magnetic permeability than the first material. The inductor assembly as discussed herein can be implemented in a circuit in which the second electrically conductive path supports current in one direction while the first electrically conductive path 10 (such as a return path) can be configured to support current in a second direction opposite the first direction.

### BACKGROUND

In general, a conventional inductor is a component comprising wire or other conductive material, which is shaped as a coil or helix to increase an amount of magnetic flux through a respective circuit path. Winding a wire into a coil of multiple turns increases the number of respective magnetic flux lines in a respective inductor component, increasing the magnetic field and thus overall inductance of the respective inductor component.

In certain instances, a conventional inductor can be fabricated via surrounding electrically conductive path with magnetically permeable material. An assembly may include multiple inductors such as formed via multiple electrically conductive paths through the magnetically permeable material.

Conventional switching power supply circuits sometimes include an energy storage component such as one or more inductors to produce an output voltage that powers a load. For example, a controller can be configured to control switching of input current through one or more inductors to an output node of a power converter to maintain a magnitude of an output voltage at the output node within a desired range.

### BRIEF DESCRIPTION

Implementation of clean energy (or green technology) is very important to reduce our impact as humans on the environment. In general, clean energy includes any evolving methods and materials to reduce an overall toxicity on the environment from energy consumption.

This disclosure includes the observation that raw energy, such as received from green energy sources or non-green energy sources, typically needs to be converted into an appropriate form (such as desired AC voltage, DC voltage, etc.) before it can be used to power end devices such as servers, computers, mobile communication devices, wireless base stations, etc. In certain instances, energy is stored in a respective one or more battery resource. Alternatively, energy is received from a voltage generator. Regardless of whether energy is received from green energy sources or non-green energy sources, it is desirable to make most efficient use of raw energy (such as storage and subsequent distribution) provided by such systems to reduce our impact on the environment. This disclosure contributes to reducing our carbon footprint and better use of energy via more efficient energy conversion.

This disclosure further includes the observation that power conversion efficiency and/or density of conventional power supplies can be improved. For example, to this end, this disclosure includes novel ways of providing improved inductor assemblies supporting power conversion.

In contrast to conventional techniques, examples herein include novel inductor assemblies as well as novel implementation of the inductor assemblies in different stacked power converter configurations and circuitry.

More specifically, an inductor assembly as discussed herein can be configured to include: first material; a first electrically conductive path extending through the first material; second material, the second material being magnetically permeable material; and a second electrically conductive path extending through the second material.

In one example, the first electrically conductive path is a so-called ground return path supporting conveyance of current conveyed over the second electrically conductive path.

In another example, the first material may envelop the first electrically conductive path. A first portion of the second material may envelop the first material. The inductor assembly may further include a third electrically conductive path extending through the second material. A second portion of the second material may envelop the third electrically conductive path. Additionally, the first electrically conductive path (such as a return current path) may be disposed in the inductor assembly between the second electrically conductive path and the third electrically conductive path.

In still further examples as discussed herein, the inductor assembly can be configured to include a first surface such as a top surface and a second surface such as a bottom surface. The first material may extend between the first surface and the second surface. The second material may also extend between the first surface and the second surface. The first electrically conductive path may extend between the first surface and the second surface; the second electrically conductive path may extend between the first surface and the second surface.

In yet further examples as discussed herein, the first material may be magnetically permeable material having a first magnetic permeability; the second material may have a second magnetic permeability. In one example, the second magnetic permeability is greater than or substantially greater than the first magnetic permeability.

In another example, the first material is non-magnetically permeable material or magnetically permeable material below a respective threshold level such that the inductance associated with the first electrically conductive path is a very small in comparison to the inductance of the second electrically conductive path.

Note that the inductor assembly as discussed herein can be configured to include any number of electrically conductive paths. In one example, the inductor assembly as discussed herein includes a third electrically conductive path extending through the second material. The first electrically conductive path may be disposed between the second electrically conductive path and the third electrically conductive path.

Yet further, note that the inductor assembly as discussed herein may include a fourth electrically conductive path extending through the second material and a fifth electrically conductive path extending through the second material. In one example, the first electrically conductive path is disposed in the inductor assembly between the fourth electrically conductive path and the fifth electrically conductive path.

Further examples as discussed herein include a circuit assembly (such as a stack of multiple components including the inductor assembly). In one example, the circuit assembly includes any implementation of the inductor assembly as discussed herein. In one example, the circuit assembly further includes: a first switch coupled between a first node of the first electrically conductive path and a first node of the second electrically conductive path. Note that the first node of the first electrically conductive path and the first node of the second electrically conductive path may extend to or through a first facing (such as surface) of the inductor assembly. The circuit may further include a second switch coupled between the first node of the second electrically conductive path and an input voltage source. A controller can be configured to control operation of the first switch and the second switch to convert an input voltage into an output voltage.

In further examples, the output voltage at least partially produced by the second electrically conductive path may be regulated. In another example, the controller is configured to receive a feedback signal indicating a magnitude of the output voltage outputted from a second node of the second electrically conductive path. Based on the magnitude of the feedback signal, the controller controls activation of the first switch and the second switch coupled to the first node of the second electrically conductive path to maintain a magnitude of the output voltage with respect to a setpoint reference voltage.

Yet further, examples herein include a circuit assembly including an implementation of the inductor assembly as discussed herein. The circuit assembly may include a load coupled to receive an output voltage generated by the second electrically conductive path. Switch circuitry in or associated with the circuit assembly is configured to control current through the second electrically conductive to produce the output voltage.

In another example, the first electrically conductive path may be an inductor having a first inductance. The inductance of the first electrically conductive path may be substantially less than the inductance of the second electrically conductive path extending through the magnetically permeable material.

In a further example, on the inductor assembly as discussed herein includes: first material enveloping a first electrically conductive path; second material enveloping the first material, the second material being magnetically permeable material; a second electrically conductive path extending through the second material, the second electrically conductive path operative to convey first current to power a load; and wherein the first electrically conductive path is a return path operative to convey the first current received from the load to a reference voltage.

The inductor assembly may further include a third electrically conductive path extending through the second material. The third electrically conductive path can be configured to convey second current to power the load. The first electrically conductive path (such as ground return path) can be configured to convey the second current received from the load to the reference voltage.

Another example as discussed herein may include a method of fabricating an inductor assembly. The method such as implemented by the fabricator or other suitable entity can be configured to include: receiving first material; receiving second material, the second material being magnetically permeable material; and fabricating the inductor assembly to include: i) a first electrically conductive path extending through the first material, and ii) a second electrically conductive path extending through the second material.

These and other more specific examples are disclosed in more detail below.

Note that any of the resources (such as a fabricator) implemented in system as discussed herein can include one or more computerized devices, controllers, mobile communication devices, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes a fabricator such as including computer readable storage medium and/or system having instructions stored thereon to fabricate an inductor device. The instructions, when executed by computer processor hardware, cause the computer processor hardware (such as one or more co-located or disparately located processor devices or hardware) to: receive first material; receive second material, the second material being magnetically permeable material; fabricate the inductor assembly such that the second material envelops the first material; and fabricate the inductor assembly to include: i) a first electrically conductive path extending through the first material, the first material enveloping the first electrically conductive path, and ii) a second electrically conductive path extending through the second material, the second material enveloping the second electrically conductive path.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

Note further that although examples as discussed herein are applicable to switching power supplies, the concepts disclosed herein may be advantageously applied to any other suitable topologies.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example 3-dimensional diagram illustrating an inductor assembly as discussed herein.

FIG. 2 is an example diagram illustrating a power converter circuit implementing an inductor assembly to produce a respective output voltage as discussed herein.

FIG. 3 is an example diagram illustrating a power converter circuit implementing an inductor assembly to produce a respective output voltage as discussed herein.

FIG. 4 is an example diagram of each respective power converter phase in a power converter circuit as discussed herein.

FIG. 5A is an example top view diagram of an inductor assembly as discussed herein.

FIG. 5B is an example side view diagram of an inductor assembly as discussed herein.

FIG. 5C is an example 3-dimensional diagram illustrating an inductor assembly as discussed herein.

FIG. 6A is an example top view diagram of an inductor assembly as discussed herein.

FIG. 6B is an example side view diagram of an inductor assembly as discussed herein.

FIG. 6C is an example 3-dimensional diagram illustrating an inductor assembly as discussed herein.

FIG. 7A is an example 3-dimensional diagram of an inductor assembly as discussed herein.

FIG. 7B is an example 3-dimensional diagram of an inductor assembly as discussed herein.

FIG. 7C is an example 3-dimensional diagram illustrating an inductor assembly as discussed herein.

FIG. 8A is an example diagram illustrating a substrate associated with a power converter as discussed herein.

FIG. 8B is an example diagram illustrating a component stack including a substrate and inductor assembly as discussed herein.

FIG. 8C is an example diagram illustrating stacking of a substrate, inductor assembly, mother board substrate, and load as discussed herein.

FIG. 9A is an example diagram illustrating a power stage substrate including switching circuitry as discussed herein.

FIG. 9B is an example diagram illustrating stack assembly of an inductor assembly onto a power stage assembly as discussed herein.

FIG. 9C is an example diagram illustrating implementation of the stack assembly of FIG. 9B embedded into a CPU substrate as discussed herein.

FIG. 9D is an example diagram illustrating coupling of a respective load such as a CPU onto the stack assembly as discussed herein.

FIG. 10 is an example top view diagram of the inductor assembly supporting multiple power converter phases as discussed herein.

FIG. 11 is an example top view diagram of the inductor assembly supporting multiple power converter phases as discussed herein.

FIG. 12 is an example diagram illustrating example computer architecture operable to execute one or more operations as discussed herein.

FIG. 13 is an example diagram illustrating a method as discussed herein.

FIG. 14 is an example diagram illustrating a method as discussed herein.

The foregoing and other objects, features, and advantages of examples herein will be apparent from the following more particular description herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

According to one configuration, an inductor assembly comprises: a first material, second material, and one or more electrically conductive paths. A first electrically conductive path (such as ground return path) extends through the first material. In one example, the first material is not magnetically permeable material or has a low magnetic permeability. The second electrically conductive path extends through the second material. In one example, the second material is magnetically permeable material and has a higher magnetic permeability than the first material. The inductor assembly as discussed herein can be implemented in a circuit in which the second electrically conductive path supports current in one direction while the first electrically conductive path (such as a return path) can be configured to support current in a second direction opposite the first direction.

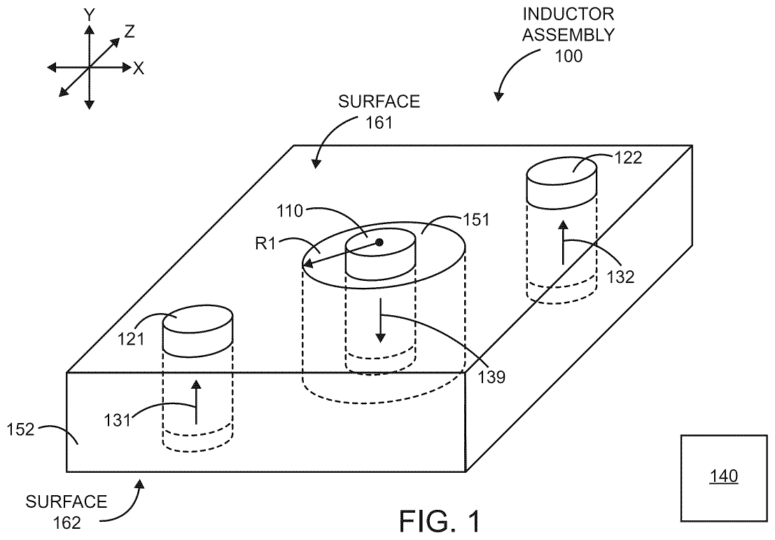

Now, with reference to the drawings, FIG. 1 is an example 3-dimensional diagram illustrating an inductor assembly as discussed herein.

In this example, the inductor assembly 100 includes first material 151, second material 152, and multiple electrically conductive paths such as electrically conductive path 110 (such as ground return path), electrically conductive path 121, and electrically conductive path 122.

Note that the number of electrically conductive paths through the first material 151 may vary depending upon the implementation. For example, the inductor assembly 100 can be configured to include one or more electrically conductive paths extending through the first material 151 such as at least between the surface 161 (top surface) and the second surface 162 (bottom surface) of the inductor assembly 100. If desired, the terminal nodes at respective axial ends of each of the electrically conductive paths through the first material 151 may extend beyond the respective surface 161 and the respective surface 162.

Note that the number of electrically conductive paths through the material 152 may vary depending upon the implementation. For example, the inductor assembly 100 can be configured to include multiple electrically conductive paths extending through the second material 152 such as at least between the surface 161 (top surface) and the second surface 162 (bottom surface) of the inductor assembly 100. If desired, the terminal nodes at respective axial ends of each of the electrically conductive paths through the second material 152 may extend beyond the respective surface 161 and the respective surface 162.

As further shown, in this example, the first material 151 envelops (i.e., surrounds, encapsulates, etc.) the first electrically conductive path 110 (such as ground return path). The electrically conductive path 110 can be configured to extend lengthwise through the inductor assembly 100 along the Y-axis. In one example, the first material 151 extends to a radius R1 with respect to the electrically conductive path 110 (such as center or other suitable location in the material 151). Along the Y-axis, the first material 151 extends at least between the first surface 161 and the second surface 162. In such an instance, the first material 151 is cylindrically shaped. However, note that the cylindrical shape is shown by way of example only. The first material 151 in the inductor assembly 100 can be formed to any suitable shape.

In further examples, the electrically conductive path 110 (such as ground return path) can be implemented as multiple electrically conductive paths extending from the bottom surface 162 through the material 151 to the top surface 161. This may be desirable in cases where a ground/current return path function is provided by the electrically conductive path 110 (such as ground return path) requires higher magnitudes of current.

Note further that the first material 151 may be fabricated from any suitable one or more materials such as plastic, etc. In one example, the first material 151 has a low magnetic permeability such as 10 percent of the magnitude of the permeability of the second material or even lower. Thus, a ratio of a magnitude of the magnetic permeability of the first material 151 with respect to a magnitude of the magnetic permeability of the second material 152 may be less than 0.1 or other suitable value. If desired, the material 151 may be non-magnetically permeable material having a magnetic permeability near vacuum or air. In such an instance, the flux density in the first material 151 based on current flowing through the electrically conductive path 110 (such as ground return path) is low, resulting in a condition in which the electrically conductive path 110 has a very small inductance, near zero inductance, or possibly no inductance at all.

The second material 152 may be fabricated from any suitable one or more materials. In one example, the second material 152 disposed outside of the radius R1 extends between the surface 161 and the surface 162. The material 152 can be configured to have a high (or higher) magnetic permeability such as 10 times (or other suitable multiplier value) the magnitude of the permeability of the first material or even higher. In such an instance, the flux density in the first material 152 (near the electrically conductive path 121) based on current flowing through the electrically conductive path 121 is high, resulting in a condition in which the electrically conductive path 121 has a higher inductance than the inductance associated with the electrically conductive path 110.

In other words, the electrically conductive path 121 may be a first inductor associated with the inductor assembly 100; the electrically conductive path 122 is a second inductor associated with the inductor assembly 100.

There are a number of parameters that can be selected to control the respective inductance of each of the electrically conductive paths (such as electrically conductive path 121, electrically conductive path 122, etc.) extending through the second material 152. For example, the length of each electrically conductive path between the surface 161 and the surface 162 can be varied such as based on a separation of the surface 161 and the surface 162 in the inductor assembly 100. The larger the separation, the higher inductance for each of the electrically conductive paths therethrough.

Additionally, the magnetic permeability of the material 152 can be chosen to control the magnitude of the inductances of electrically conductive path extending through the material 152.

The higher the magnetic permeability of the material 152, the higher the respective inductances of the electrically conductive paths.

As previously discussed, the magnetic permeability of the second material 152 may be greater than the magnetic permeability of the first material 151. Thus, in one example, the inductances of each of the electrically conductive paths 121, 122, etc., is greater than the inductance of the first electrically conductive path 110 (which is a potentially very low or near zero inductance as previously discussed).

Yet further, as shown, a portion of the second material 152 in the inductor assembly 100 envelops the first material 151. More specifically, beyond radius R1 with respect to the electrically conductive path 110 (such as ground return path), the inductor assembly 100 includes second material 152 surrounding the material 151.

As more specifically shown in FIG. 1, the second material 152 may envelop (i.e., surround, encapsulate, etc.) each of the one or more electrically conductive path extending through the inductor assembly 100. The location of the electrically conductive path 110 (such as ground return path) in the first material 151 ensures sufficient separation of the electrically conductive path 110 with respect to the magnetically permeable material 152, thus preventing the electrically conductive path 110 from having a high inductance or at least ensuring that the inductance of the electric conductive path 110 is zero or near zero or at least less than a magnitude of the inductance associated with the electrically conductive paths 121 and 122.

In this example, inductor assembly 100 includes electrically conductive path 121, electrically conductive path 122 extending through the second material 152. The electrically conductive path 121 and electrically conductive path 122 extend lengthwise along the Y-axis. A first portion of the material 152 envelops the electrically conductive path 121; a second portion of the material 152 envelops the electrically conductive path 122.

The shape of the material 152 associated with the inductor assembly 100 is shown by way of example only. The second material 152 in the inductor assembly 100 can be formed to any suitable shape.

Yet further, the electrically conductive path 121 and electrically conductive path 122 can be disposed at any location in the inductor assembly 100. In one example, the electrically conductive path 110 is disposed in the inductor assembly 100 between the electrically conductive path 121 and the electrically conductive path 122.

Accordingly, examples herein include the inductor assembly 100 comprising: first material 151, a first electrically conductive path 110 extending through the first material 151; second material 152 such as magnetically permeable material; and a second electrically conductive path 121 and third electrically conductive path 122 extending through the second material.

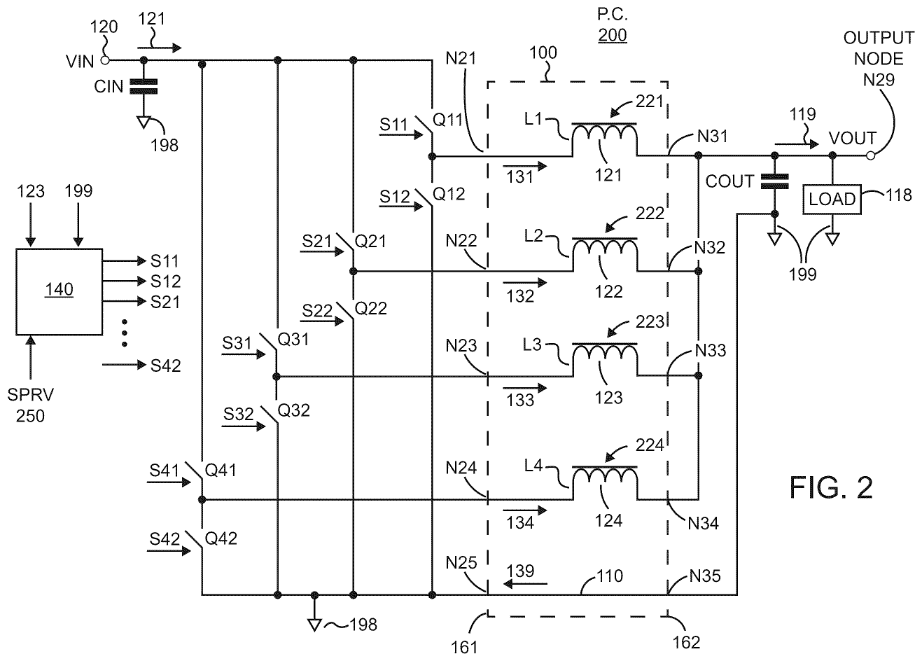

FIG. 2 is an example diagram illustrating a power converter circuit implementing an inductor assembly to produce a respective output voltage as discussed herein.

In one example, the power converter 200 is implemented as multi-phase buck converter including any number of power converter phases. Assuming that there are 4 power converter phases, the power converter 200 includes four pairs of switches, four-phase low-profile inductors with short current flow path and ground return path disposed in the inductor assembly 100, and one or more decoupling capacitors Cin and Cout.

More specifically, the first power converter phase 221 in the power converter 200 includes switch Q11, switch Q12, and inductor L1 (electrically conductive path 121). The controller 140 monitors the magnitude of the output voltage 119 with respect to the ground reference voltage 199 (such as a differential voltage) and compares the magnitude of the output voltage 119 to a desired setpoint reference voltage 250 such as 1 volt DC or other suitable reference value. Based on an error voltage indicating a difference between the differential voltage (basically the output voltage 119) and the setpoint reference voltage 250, the controller 140 generates the control signals S11 and S12 to control respective switches Q11 and Q12. As shown, control of the switches Q11 and Q12 results in flow of respect current 131 through the electrically conductive path 121 (a.k.a., inductor L1) to the output node N29 of the power converter 200.

The second power converter phase 222 in the power converter 200 includes switch Q21, switch Q22, and inductor L2 (electrically conductive path 122). The controller 140 monitors the magnitude of the output voltage 119 with respect to the ground reference voltage 199 (such as a differential voltage) and compares this to a desired setpoint reference voltage 250 such as 1 volt DC or other suitable value. Based on an error voltage indicating a difference between the differential voltage (basically the output voltage 119) and the setpoint reference voltage 250, the controller 140 generates the control signals S21 and S22 to control respective switches Q21 and Q22. As shown, control of the switches Q21 and Q22 results in flow of respect current 132 through the electrically conductive path 122 (a.k.a., inductor L2) to the output node N29 of the power converter 200.

The power converter phase 223 in the power converter 200 includes switch Q31, switch Q32, and inductor L3 (electrically conductive path 123). The controller 140 monitors the magnitude of the output voltage 119 with respect to the ground reference voltage 199 (such as a differential voltage) and compares this to a desired setpoint reference voltage 250 such as 1 volt DC or other suitable value. Based on an error voltage indicating a difference between the differential voltage (basically the output voltage 119) and the setpoint reference voltage 250, the controller 140 generates the control signals S31 and S32 to control respective switches Q31 and Q32. As shown, control of the switches Q31 and Q32 results in flow of respect current 133 through the electrically conductive path 123 (a.k.a., inductor L3) to the output node N29 of the power converter 200.

The power converter phase 224 in the power converter 200 includes switch Q41, switch Q42, and inductor L4 (electrically conductive path 124). The controller 140 monitors the magnitude of the output voltage 133 with respect to the ground reference voltage 199 (such as a differential voltage) and compares this to a desired setpoint reference voltage 250 such as 1 volt DC or other suitable value. Based on an error voltage indicating a difference between the differential voltage (basically the output voltage 119) and the setpoint reference voltage 250, the controller 140 generates the control signals S41 and S42 to control respective switches Q41 and Q42. As shown, control of the switches Q41 and Q42 results in flow of respect current 134 through the electrically conductive path 124 (a.k.a., inductor L4) to the output node N29 of the power converter 200.

Based on generation of the control signals by the controller 140 and flow of respective currents 131, 132, 133, 134, the magnitude of the output voltage 119 is approximately equal to the setpoint reference voltage 250.

In one example, the return current 139 through the electrically conductive path 110 is equal to a summation of the current 131, current 132, current 133, and current 134. In other words, the total current supplied to the load 118 from the multiple power converter phases passes through the load 118 and returns through the electrically conductive path 110 to the ground reference voltage 198.

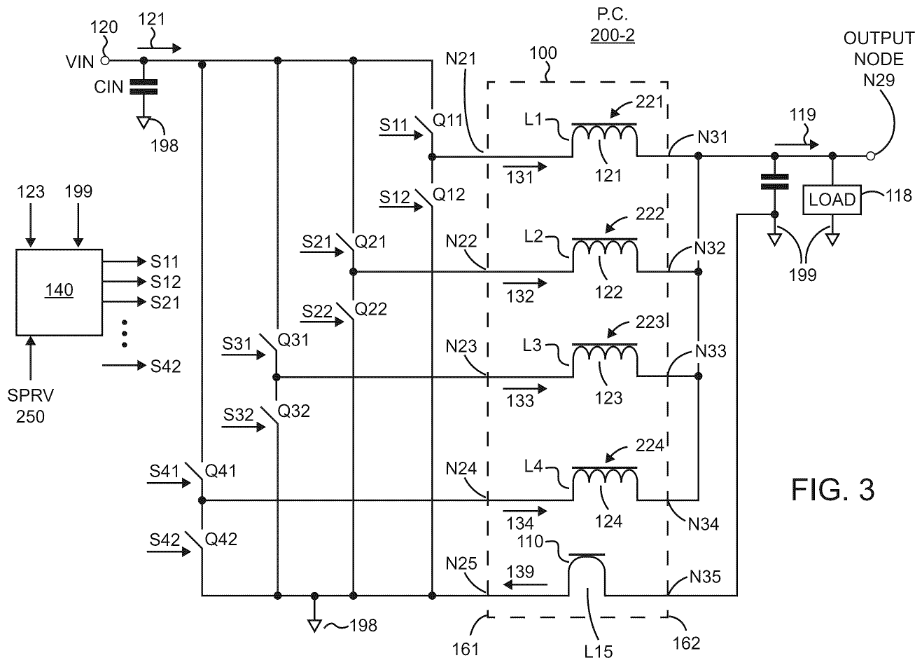

FIG. 3 is an example diagram illustrating a power converter circuit implementing an inductor assembly to produce a respective output voltage as discussed herein.

The implementation of the power converter 200-2 is almost identical to the implementation of the power converter 200 as previously discussed with respect to FIG. 3.

However, if desired, the material 152 may be chosen to have a magnetic permeability greater than a magnetic permeability of air or a vacuum. In such an instance, the electrically conductive path 110 through the inductor assembly 100 is an inductor, having an inductance (large or small or zero or nonzero) defined by the magnetic permeability of the material 152 as well as a length of the electrically conductive path 110 between the surface 161 and surface 162.

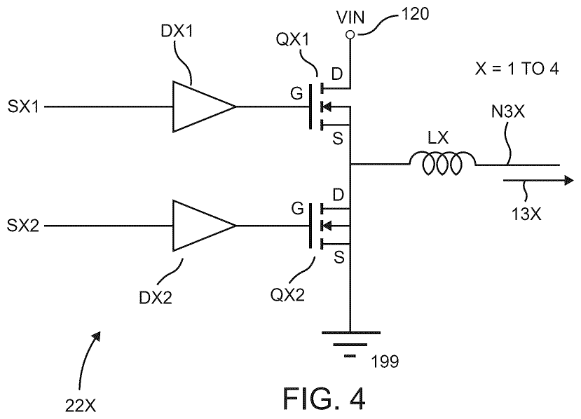

FIG. 4 is an example diagram illustrating a respective power converter phases as discussed herein.

In this example, each of the power converter phases 22X (where X is an integer value indicating a phase, where X=1 corresponds to a power converter phase 221, where X=2 corresponds to power converter phase 222, etc.) in the power converter 200 (i.e., circuit) includes an inductor LX, high-side switch QX1, low-side switch QX2, driver DX1, and driver DX2.

Note that any of the switches (a.k.a., switch circuitry) as discussed herein can be implemented in any suitable manner such as via MOSFETs, semiconductor material including GaN and SiC; and any power semiconductor including BJT, IGBT, JFET, etc.

The switch QX1 and switch QX2 of a respective power converter phase 22X are connected in series between the input voltage source 120 and a ground voltage reference 199. For example, the drain (D) of switch QX1 is connected to receive the input voltage 121 from the input voltage source 120; the source(S) of switch QX1 is connected to the drain (D) of switch QX2; the source(S) of switch QX2 is connected to the ground voltage reference 199. A first end of the inductor LX is connected to the source node of switch QX1 and drain node of switch QX2. A second end of the inductor LX is connected to the node N3X (or node N29).

Note that the ground reference voltage 199 may be the same as ground reference voltage 198 or different than the ground reference voltage 198.

Via the control signals SX1 and SX2 produced by the controller 140 for a given power converter phase 22X, the controller 140 controls operation of the switches in the respective power converter phase 22X. For example, activation of the high-side switch QX1 while the low-side switch QX2 is deactivated causes a magnitude of the current 13X to increase during a respective control cycle; deactivation of the high-side switch QX1 while the low-side switch QX2 is activated causes a magnitude of the current 13X to decrease during a respective control cycle. As discussed herein, the controller 140 can be configured to vary the duty cycle of generating the control signals SX1 and SX2 to control a magnitude of the output current 13X supplied to the dynamic load 118. Driver DX1 receives signal SX1 and drives the gate node of the switch QX1 with the signal SX1. Driver DX2 receives signal SX2 and drives the gate node of the switch QX2 with the signal SX2.

Note further that controller 140 and/or the driver circuitry DX1 and DX2 can be configured to implement a dead time such that switches QX1 and QX2 are not simultaneously activated to prevent shorting of the input voltage source 120 and input voltage 121 to the ground reference voltage 199.

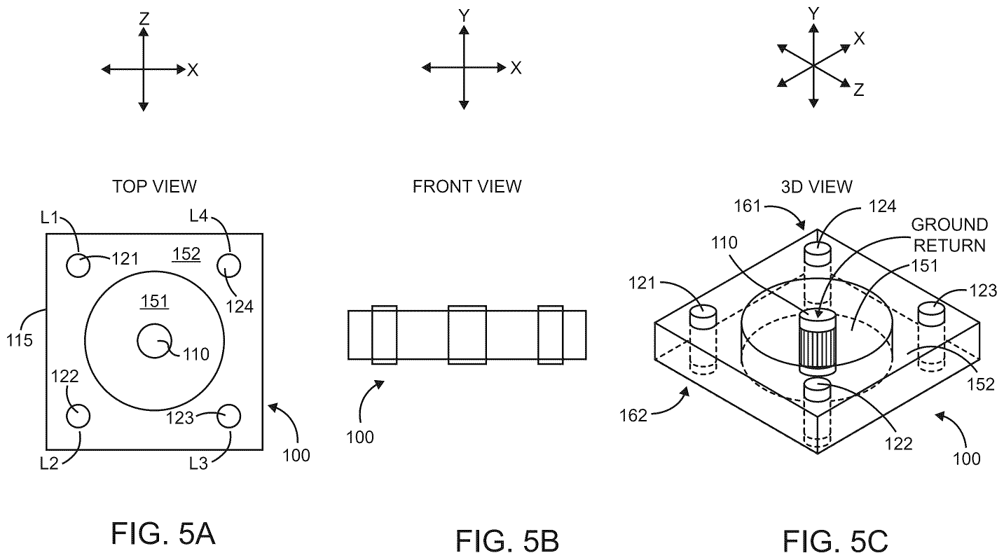

FIG. 5A is an example top view diagram of an inductor assembly as discussed herein.

In this example, the inductor assembly 100 includes electrically conductive path 121 (inductor L1 or winding), electrically conductive path 122 (inductor L2 or winding), electrically conductive path 123 (inductor L3 or winding), and electrically conductive path 124 (inductor L4 or winding).

As previously discussed, the electrically conductive path 110 (such as operative to support return current) may have a zero inductance, near zero inductance, or some other magnitude of inductance. Further, as previously discussed, additional electrically conductive paths can be configured to extend through the material 151 similar to electrically conductive path 110.

In one example, the inductors disposed in the inductor assembly 100 are so-called low-profile inductors.

Further in this example, it is noted that the electrically conductive path 110 is disposed in the inductor assembly 100 between the electrically conductive path 121 and the electrically conductive path 123. The electrically conductive path 110 is also disposed between the electrically conductive path 122 and the electrically conductive path 124. In such an instance, in contrast to conventional techniques of providing a return path on the outside of a respective inductor assembly, the return path (electrically conductive path 110) as shown in FIG. 5A is disposed in the inductor assembly 100 inside a perimeter defined by the electrically conductive paths 121, 122, 123, and 124.

FIG. 5B is an example side view diagram of an inductor assembly as discussed herein.

In this example, as previously discussed, the inductor assembly 100 can be configured to include multiple electrically conductive path extending at least from the surface 161 to the surface 162.

FIG. 5C is an example 3-dimensional diagram illustrating an inductor assembly as discussed herein.

In this example, as previously discussed, the inductor assembly 100 can be configured to include multiple electrically conductive path extending at least from the surface 161 to the surface 162.

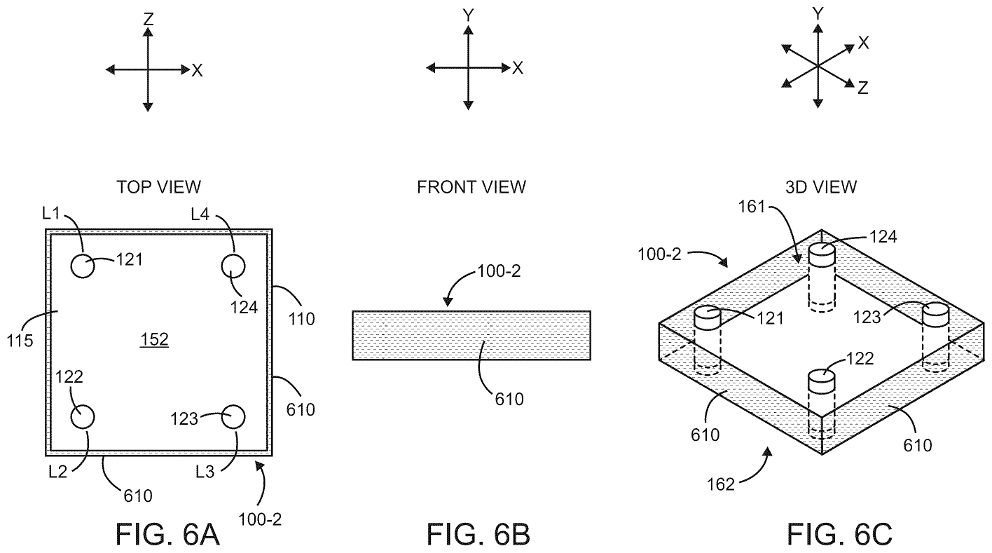

FIG. 6A is an example top view diagram of an inductor assembly as discussed herein.

In this example, the assembly 100-2 is similar to the assembly 100 as previously discussed. However, the assembly 100-2 does not include the material 151 or the electrically conductive path 110. Instead, the assembly 100-2 includes the electrically conductive path 610 disposed at a perimeter (outer surface) of the material 152 and corresponding assembly 100-2.

The electrically conductive path 610 supports the return path function similar to the electrically conductive path 110 as previously discussed. In such an instance, the respective current 131, 132, 133, 134, are supplied by the respective electrically conductive paths 121, 122, 123, and 124. The corresponding return current 139 associated with the respective current 131, 132, 133, 134, is conveyed on the electrically conductive path 610 disposed on an outer surface of the inductor assembly 100-2.

FIG. 6B is an example side view diagram of an inductor assembly as discussed herein.

In this example, as previously discussed, the inductor assembly 100 can be configured to include multiple electrically conductive path extending at least from the surface 161 to the surface 162. The outer surface of the assembly 100-2 includes the electrically conductive path 610.

FIG. 6C is an example 3-dimensional diagram illustrating an inductor assembly as discussed herein.

In this example, as previously discussed, the inductor assembly 100 can be configured to include multiple electrically conductive path extending at least from the surface 161 to the surface 162. The outer surface of the assembly 100-2 includes the electrically conductive path 610.

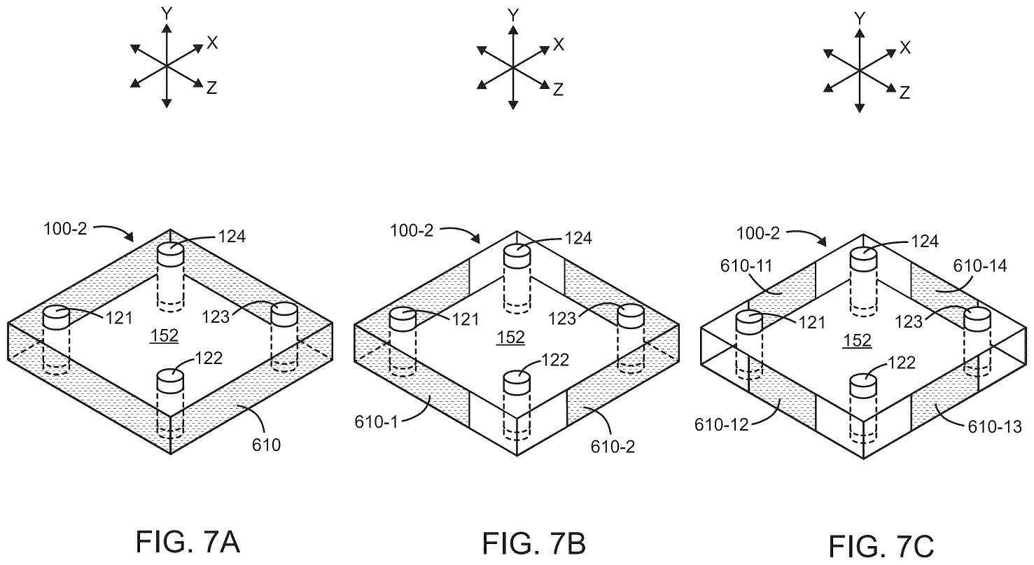

FIG. 7A is an example diagram illustrating implementation of a voltage regulator including an inductor assembly as discussed herein.

In this example, the inductor assembly 100-2 includes a continuous layer of electrically conductive material 610 enveloping the material 152 and corresponding inductor assembly 100-2.

FIG. 7B is an example diagram illustrating implementation of multiple voltage regulators including an inductor assembly as discussed herein.

In this example, the inductor assembly 100-2 includes multiple portions of electrically conductive material 610 such as electrically conductive material 610-1 and electrically conductive material 610-2. Thus, the electrically conductive material may not completely encompass the inductor assembly 100-2.

In such an instance, the assembly 100-2 includes multiple electrically conductive paths 121, 122, 123, 124 passing through the magnetically permeable material 152. The electrically conductive path 610-1 and electrically conductive path 610-2 can be used as multiple ground return paths disposed on the outer perimeter of the inductor assembly 100-2.

FIG. 7C is an example diagram illustrating implementation of multiple voltage regulators including an inductor assembly as discussed herein.

In this example, the inductor assembly 100-2 includes multiple portions of electrically conductive material 610 such as electrically conductive material 610-11, electrically conductive material 610-12, electrically conductive material 610-13, and the electrically conductive material 610-14. The electrically conductive material does not completely encompass the inductor assembly 100-2.

In such an instance, the assembly 100-2 includes multiple electrically conductive paths 121, 122, 123, 124 passing through the magnetically permeable material 152. The electrically conductive path 610-11, electrically conductive path 610-12, electrically conductive path 610-13, and electrically conductive path 610-14 can be used as multiple ground return paths disposed on the outer perimeter of the inductor assembly 100-2.

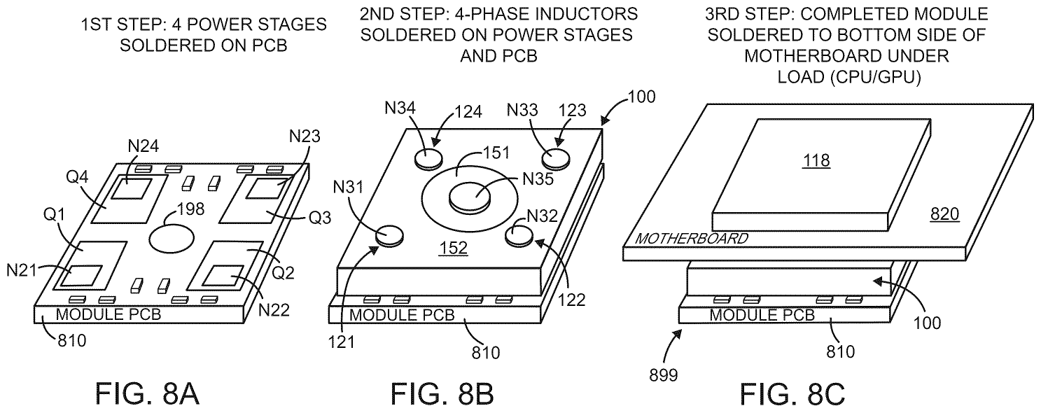

FIG. 8A is an example diagram illustrating a substrate associated with a power converter as discussed herein.

In this example, the switching circuitry as previously discussed can be disposed on a respective substrate 810.

For example, switch circuitry Q1 (such as combination of switch Q11 and switch Q12) associated with the first power converter phase 221 is disposed on or in the substrate 810. Further, as previously discussed, the switch circuitry Q1 controls output of current 131 supplied through the node N21 to the inductor L1.

Switch circuitry Q2 (such as combination of switch Q21 and switch Q22) associated with the power converter phase 222 is disposed on or in the substrate 810. Further, as previously discussed, the switch circuitry Q2 controls output of current 132 supplied through the node N22 to the inductor L2.

Switch circuitry Q3 (such as combination of switch Q31 and switch Q32) associated with the power converter phase 223 is disposed on or in the substrate 810. Further, as previously discussed, the switch circuitry Q3 controls output of current 133 supplied through the node N23 to the inductor L3.

Switch circuitry Q4 (such as combination of switch Q41 and switch Q42) associated with the power converter phase 224 is disposed on or in the substrate 810. Further, as previously discussed, the switch circuitry Q4 controls output of current 134 supplied through the node N24 to the inductor L4.

FIG. 8B is an example diagram illustrating a compliment stack including a substrate and inductor assembly as discussed herein.

In this example, the assembly 100 is affixed to the substrate 810 such that: i) the switch circuitry Q1 (combination of switch Q11 and switch Q12) controls current through the electrically conductive path 121; the axial end of the electrically conductive path 121 on the bottom surface 162 of the assembly 100 is connected to the node N21, ii) the switch circuitry Q2 (combination of switch Q21 and switch Q22) controls current through the electrically conductive path 122; the axial end of the electrically conductive path 122 on the bottom surface 162 of the assembly 100 is connected to the node N22, iii) the switch circuitry Q3 (combination of switch Q31 and switch Q32) controls current through the electrically conductive path 123; the axial end of the electrically conductive path 123 on the bottom surface 162 of the assembly 100 is connected to the node N23, iv) the switch circuitry Q4 (combination of switch Q41 and switch Q42) controls current through the electrically conductive path 124; the axial end of the electrically conductive path 124 on the bottom surface 162 of the assembly 100 is connected to the node N24.

The axial end of the electrically conductive path 110 on the bottom surface 162 is connected to the node N25 such as ground reference voltage 198.

FIG. 8C is an example diagram illustrating stacking of a substrate, inductor assembly, mother board, and load as discussed herein.

In this example, the circuitry 899 (assembly stack) includes a stacking of the substrate 810, inductor assembly 100, substrate 820, and the load 118. As previously discussed, the inductors L1, L2, L3, and L4 in the inductor assembly 100 output respective currents 131, 132, 133, 134 from the top of the inductor assembly 100 to the bottom surface of substrate 820. The substrate 820 can be configured to include electrically conductive paths to convey the received output currents 131, 132, 133, 134 and thus output voltage 119 to the load 118. The load 118 is coupled to the top surface of the substrate 820 to receive the output voltage 119 and corresponding currents supplied by the power converter phases.

The short distance from the switching converter (such as switch circuitry on substrate 810) to the CPU (dynamic load 118) reduces parasitic inductance and resistance of the power distribution network, which improves load transient response and reduces power distribution loss.

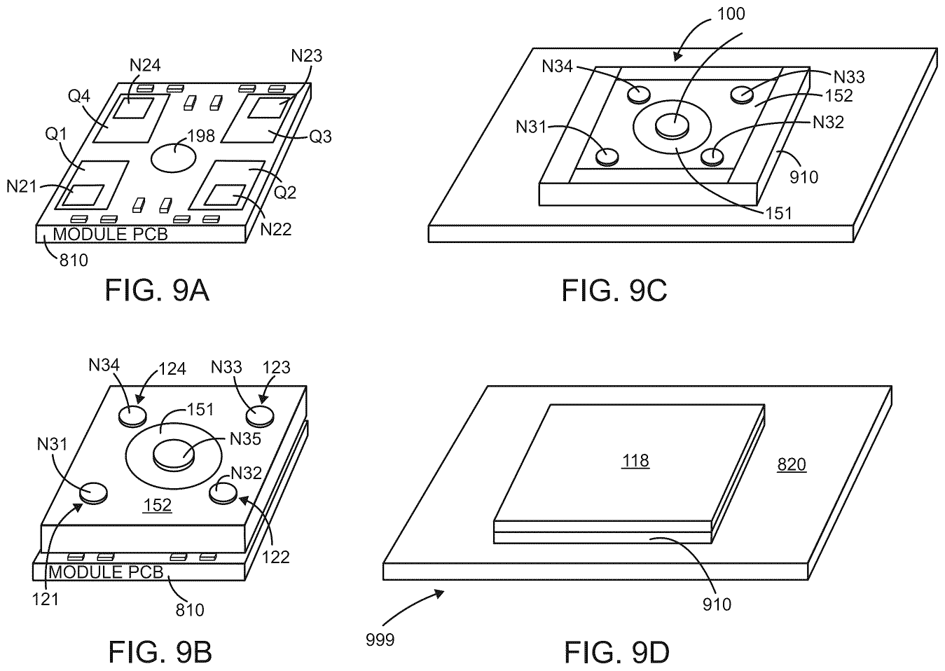

FIG. 9A is an example diagram illustrating a power stage substrate as discussed herein.

In this example, the switching circuitry as previously discussed can be disposed on a respective substrate 810.

For example, switch circuitry Q1 (such as combination of switch Q11 and switch Q12) associated with the first power converter phase 221 is disposed on or in the substrate 810. Further, as previously discussed, the switch circuitry Q1 controls output of current 131 supplied through the node N21 to the inductor L1.

Switch circuitry Q2 (such as combination of switch Q21 and switch Q22) associated with the power converter phase 222 is disposed on or in the substrate 810. Further, as previously discussed, the switch circuitry Q2 controls output of current 132 supplied through the node N22 to the inductor L2.

Switch circuitry Q3 (such as combination of switch Q31 and switch Q32) associated with the power converter phase 223 is disposed on or in the substrate 810. Further, as previously discussed, the switch circuitry Q3 controls output of current 133 supplied through the node N23 to the inductor L3.

Switch circuitry Q4 (such as combination of switch Q41 and switch Q42) associated with the power converter phase 224 is disposed on or in the substrate 810. Further, as previously discussed, the switch circuitry Q4 controls output of current 134 supplied through the node N24 to the inductor L4.

FIG. 9B is an example diagram illustrating stack assembly of an inductor assembly onto a power stage assembly as discussed herein.

In this example, the assembly 100 is affixed to the substrate 810 such that: i) the switch circuitry Q1 (combination of switch Q11 and switch Q12) controls current through the electrically conductive path 121; the axial end of the electrically conductive path 121 on the bottom surface 162 of the assembly 100 is connected to the node N21, ii) the switch circuitry Q2 (combination of switch Q21 and switch Q22) controls current through the electrically conductive path 122; the axial end of the electrically conductive path 122 on the bottom surface 162 of the assembly 100 is connected to the node N22, iii) the switch circuitry Q3 (combination of switch Q31 and switch Q32) controls current through the electrically conductive path 123; the axial end of the electrically conductive path 123 on the bottom surface 162 of the assembly 100 is connected to the node N23, iv) the switch circuitry Q4 (combination of switch Q41 and switch Q42) controls current through the electrically conductive path 124; the axial end of the electrically conductive path 124 on the bottom surface 162 of the assembly 100 is connected to the node N24.

FIG. 9C is an example diagram illustrating implementation of the stack assembly embedded into a CPU or GPU substrate as discussed herein.

As shown in this example, the inductor assembly 100 and substrate 810 are disposed in (such as embedded in) the respective substrate 910.

FIG. 9D is an example diagram illustrating coupling of a respective load such as a CPU onto the stack assembly as discussed herein.

In this example, the bottom surface of dynamic load 118 is directly connected to the top surface of the substrate 910 and corresponding inductor assembly 100.

Thus, in this example, four-phase switching converter (such as power converter phases 221, 222, 223, 224) is embedded inside a substrate 910, which resides below the load 118 such as a CPU die (Central Processing Unit or one more semiconductor chips). The substrate 910 including the power converter 200 and corresponding power converter phases is disposed between the load 118 and the substrate 820.

Thus, in one example, the switching circuit assembly (such as switches associated with the power converter 200) can be placed on a top surface of the substrate 820. The circuitry 999 includes a stacking of the dynamic load 118 on the substrate 910 as well as the substrate 910 affixed to the substrate 820. Accordingly, the substrate 910 (such as an assembly) is disposed between the dynamic load 118 and the substrate 820 such as a mother board.

In this implementation, the power delivery from the switching converter and corresponding switch circuitry to load 118 does not pass through the motherboard, which further reduces distance from the switching converter to the load 118, improving load transient response, and reducing power distribution loss.

Note again that the novel implementation of the assembly 100 is not limited to buck converters. The assembly 100 can be used in any implementation such as further including boost converters, or any other topology that delivers power to a respective load.

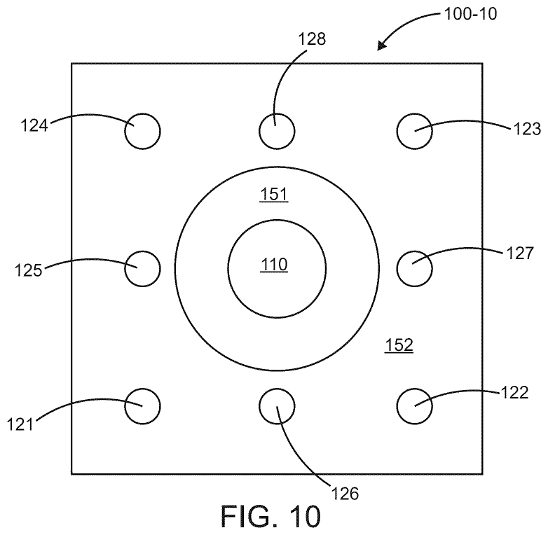

FIG. 10 is an example top view diagram of the inductor assembly supporting eight power converter phases as discussed herein.

This example of the inductor assembly 100-10 illustrates that the respective inductor assembly can be configured to include any number of electrically conductive paths extending through the material 152. For example, the assembly 100-10 includes electrically conductive paths as previously discussed as well as additional electrically conductive path 125 (inductor L5), electrically conductive path 126 (inductor L6), electrically conductive path 127 (inductor L7), and electrically conductive path 128 (inductor L8).

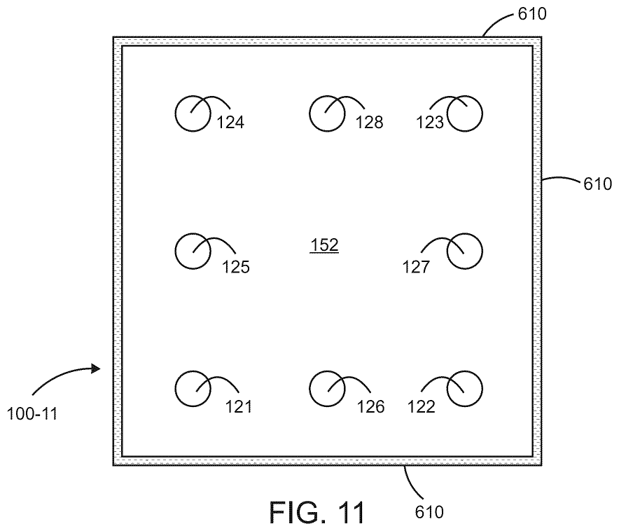

FIG. 11 is an example top view diagram of the inductor assembly supporting eight power converter phases as discussed herein.

This example of the inductor assembly 100-11 illustrates the respective inductor assembly as discussed herein without the electrically conductive path 110 can be configured to include any number of electrically conductive paths extending through the material 152. For example, the assembly 100-11 includes electrically conductive paths as previously discussed as well as electrically conductive path 125 (inductor L5), electrically conductive path 126 (inductor L6), electrically conductive path 127 (inductor L7), and electrically conductive path 128 (inductor L8).

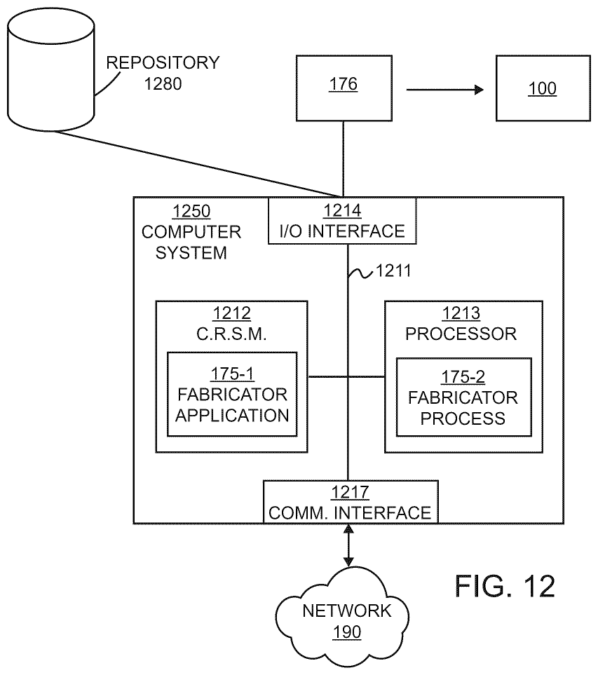

FIG. 12 is a diagram illustrating example computer architecture operable to execute one or more methods according to examples herein.

In this example, the fabricator 176 is configured to produce/fabricate the assembly 100 and/output any circuit assemblies as discussed herein. Note that the fabricator resources 175-1, 175-2 and/or fabricator resource 176 can be implemented as fabricator hardware, fabricator software, or a combination of fabricator hardware and fabrication software.

As shown, computer system 1250 of the present example includes an interconnect 1211 that couples computer readable storage media 1212 such as a non-transitory type of media (which can be any suitable type of hardware storage hardware in which digital information can be stored and retrieved), a processor 1213 (computer processor hardware), I/O interface 1214, and a communications interface 1217.

I/O interface(s) 1214 supports connectivity to external resources such as fabricator resource 176, repository 1280, keyboard, display screen, repository, etc.

Computer readable storage media 1212 can be any hardware storage device such as memory, optical storage, hard drive, floppy disk, etc. In one example, the computer readable storage medium 1212 stores instructions and/or data.

As shown, computer readable storage media 1212 can be encoded with fabricator application 175-1 (e.g., including instructions) to carry out any of the operations as discussed herein.

During operation of one example, processor 1213 accesses computer readable storage media 1212 via the use of interconnect 1211 in order to launch, run, execute, interpret or otherwise perform the instructions in fabricator application 175-1 stored on computer readable storage medium 1212. Execution of the fabricator application 175-1 produces fabricator process 175-2 to carry out any of the operations and/or processes as discussed herein.

Those skilled in the art will understand that the computer system 1200 can include other processes and/or software and hardware components, such as an operating system that controls allocation and use of hardware resources to execute fabricator application 175-1.

In accordance with different examples, note that computer system may reside in any of various types of devices, including, but not limited to, a power supply, switched-capacitor converter, power converter, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1250 may reside at any location or can be included in any suitable resource in any network environment to implement functionality as discussed herein.

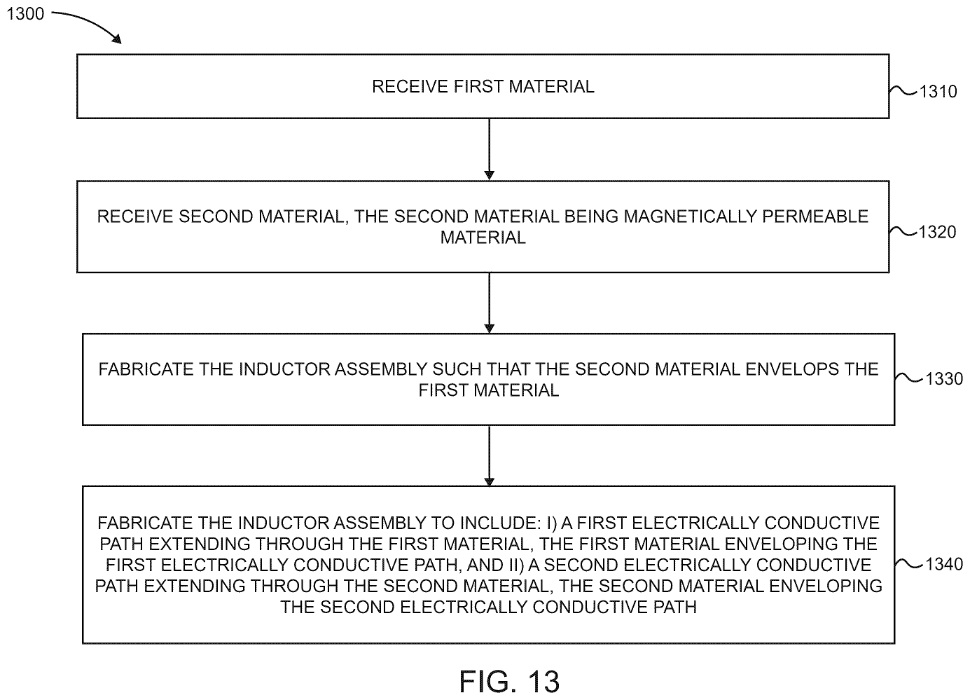

Functionality supported by one or more resources as described herein are discussed via flowchart in FIG. 13. Note that the steps in the flowcharts below can be executed in any suitable order.

FIG. 13 is a flowchart 1300 illustrating an example method as discussed herein. Note that there will be some overlap with respect to concepts as discussed above.

In processing operation 1310, the fabricator 175 receives first material 151 such as a non-magnetically permeable material or material having a low magnetic permeability below a threshold level.

In processing operation 1320, the fabricator 175 receives second material 152. The second material may be magnetically permeable material.

In processing operation 1330, the fabricator 175 fabricates the inductor assembly 100 such that the second material envelops the first material.

In processing operation 1340, the fabricator fabricates the inductor assembly 100 to include: i) a first electrically conductive path 110 extending through the first material, the first material enveloping the first electrically conductive path, ii) a second electrically conductive path 121 extending through the second material where a first portion of the second material 152 envelops (surrounds or encompasses) the second electrically conductive path, and iii) a third electrically conductive path 122 extending through the second material where a second portion of the second material envelops (surrounds or encompasses) the third electrically conductive path.

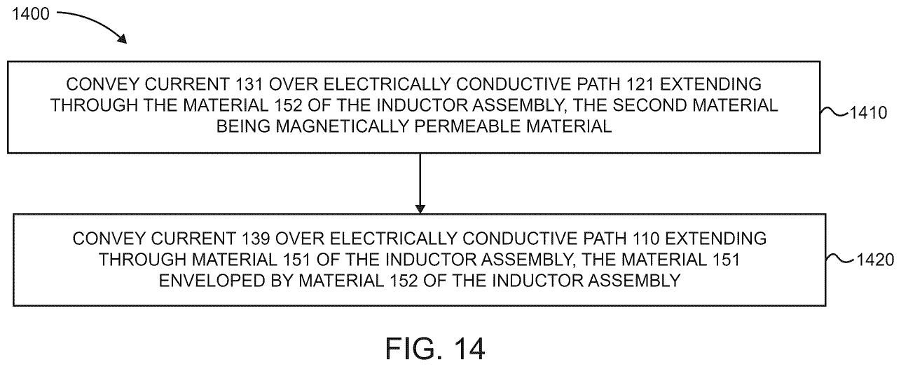

FIG. 14 is a flowchart 1400 illustrating an example method according to examples as discussed herein. Note that there will be some overlap with respect to concepts as discussed above.

In operation 1410, the inductor assembly 100 conveys first current 131 from the power converter 200 over electrically conductive path 121. As previously discussed, the electrically conductive path 121 extends through the material 152 of the inductor assembly 100. The material 152 (magnetically permeable material) envelops the electrically conductive path 121 to create a respective inductor L1. In a similar manner, the inductor assembly 100 can be configured to include multiple electrically conductive paths (inductors) to supply current to a respective load 118.

In operation 1420, the inductor assembly 100 conveys second current over the electrically conductive path 110. As previously discussed, the electrically conductive path 110 extends through the material 151 of the inductor assembly 100. The conductive path 110 supports conveyance of return current (such as combined current 131, current 132, etc.) from the load 118 to a ground reference voltage 199 associated with the power converter 200.

Note again that techniques herein are well suited for use in inductor and power converter applications. However, it should be noted that examples herein are not limited to use in such applications and that the techniques discussed herein are well suited for other applications as well.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. An inductor assembly comprising:
first material;
a first electrically conductive path extending through the first material;
second material, the second material being magnetically permeable material; and
a second electrically conductive path extending through the second material.

2. The inductor assembly as in claim 1, wherein the first material envelops the first electrically conductive path; and
wherein a first portion of the second material envelops the first material.

3. The inductor assembly as in claim 2 further comprising:
a third electrically conductive path extending through the second material;
wherein a second portion of the second material envelops the first material.

4. The inductor assembly as in claim 3, wherein the first electrically conductive path is disposed in the inductor assembly between the second electrically conductive path and the third electrically conductive path.

5. The inductor assembly as in claim 1 further comprising:
a first surface;
a second surface;
wherein the first material extends between the first surface and the second surface; and
wherein the second material extends between the first surface and the second surface.

6. The inductor assembly as in claim 5, wherein the first electrically conductive path extends between the first surface and the second surface; and
wherein the second electrically conductive path extends between the first surface and the second surface.

7. The inductor assembly as in claim 1, wherein the first material is magnetically permeable material having a first magnetic permeability;
wherein the second material has a second magnetic permeability; and
wherein the second magnetic permeability is greater than the first magnetic permeability.

8. The inductor assembly as in claim 1, wherein the first material is non-magnetically permeable material.

9. The inductor assembly as in claim 1 further comprising:
a third electrically conductive path extending through the second material;
a fourth electrically conductive path extending through the second material;
a fifth electrically conductive path extending through the second material;
wherein the first electrically conductive path is disposed between the second electrically conductive path and the third electrically conductive path; and
wherein the first electrically conductive path is disposed between the fourth electrically conductive path and the fifth electrically conductive path.

10. The inductor assembly as in claim 9, wherein the first electrically conductive path is disposed at a center of the first material.

11. The inductor assembly as in claim 1 further comprising:
a third electrically conductive path extending through the first material, the third electrically conductive path enveloped by the first material.

12. A circuit assembly including the inductor assembly of claim 1, the circuit assembly further comprising:
a first switch coupled between a first node of the first electrically conductive path and a first node of the second electrically conductive path; and
wherein the first node of the first electrically conductive path and the first node of the second electrically conductive path extend through a first facing of the inductor assembly.

13. The circuit assembly as in claim 12 further comprising:
a second switch coupled between the first node of the second electrically conductive path and an input voltage source; and
a controller operative to control operation of the first switch and the second switch to convert an input voltage into an output voltage.

14. The circuitry assembly as in claim 13, wherein the controller is operative to receive a feedback signal indicating a magnitude of the output voltage outputted from a second node of the second electrically conductive path.

15. A circuit assembly including the inductor assembly of claim 1, the circuit assembly further comprising:
a load coupled to receive an output voltage generated by the second electrically conductive path; and
switch circuitry operative to control current through the second electrically conductive to produce the output voltage.

16. The apparatus as in claim 1, wherein an inductance of the first electrically conductive path is substantially less than the inductance of the second electrically conductive path.

17. An inductor assembly comprising:
first material enveloping a first electrically conductive path;
second material enveloping the first material, the second material being magnetically permeable material;
a second electrically conductive path extending through the second material, the second electrically conductive path operative to convey first current to power a load; and
wherein the first electrically conductive path is a return path operative to convey the first current received from the load to a reference voltage.

18. The inductor assembly as in claim 17 further comprising:
a third electrically conductive path extending through the second material, the third electrically conductive path operative convey second current to power the load; and
wherein the first electrically conductive path is operative to convey the second current received from the load to the reference voltage.

19. A method comprising:
conveying first current over a first electrically conductive path extending through first material of an inductor assembly, the first material enveloped by second material of the inductor assembly; and
conveying second current over a second electrically conductive path extending through the second material of the inductor assembly, the second material being magnetically permeable material.

20. A method of fabricating an inductor assembly, the method comprising:
receiving first material;
receiving second material, the second material being magnetically permeable material; and
fabricating the inductor assembly to include: i) a first electrically conductive path extending through the first material, and ii) a second electrically conductive path extending through the second material.
